(19) United States
(12) Patent Application Publication
(10) Pub. No.: US 2011/0141026 A1
(43) Pub. Date: Jun. 16, 2011

(54) MULTICONTACT TOUCH-SENSITIVE SENSOR INCLUDING VARIABLE-SIZE AND VARIABLE-IMPEDANCE SPACING MEANS

(75) Inventors: Pascal Joquet, Sadirac (FR); Julien Olivier, Bordeaux (FR)

(73) Assignee: Stantum, Bordeaux (FR)

(21) Appl. No.: 13/057,582

(22) PCT Filed: Aug. 5, 2009
(86) PCT No.: PCT/FR2009/000978

§ 371 Date: Feb. 4, 2011

(30) Foreign Application Priority Data
Aug. 5, 2008 (FR) 08/04469

(51) Int. Cl. G06F 3/02; G06F 3/041

(52) U.S. Cl. 345/168; 345/173

(57) ABSTRACT

A multi-contact tactile sensor including an elastically deformable interaction layer and a supporting layer, a lower surface of the interaction layer including an array of strip conductors and an upper surface of the supporting layer including an array of strip conductors that are not parallel to the array of strip conductors on the interaction layer. The interaction layer and the supporting layer are separated by a first series of rigid insulating spacers. A second series of conducting spacers is in contact with at least one of the two arrays of strip conductors. The impedance and dimensions of the spacers of the second series are determined to prevent contact at rest and enable local contact during deformation of the interaction layer between the spacers of the second series and the array of strip conductors of the layer opposite the spacers. A controller can control one such sensor, a multi-contact tactile screen can include one such sensor, and a keyboard including a set of discrete keys can be formed by one such sensor.

The present invention concerns a multicontact touch-sensitive sensor including variable-size and variable-impedance spacing means.

### TECHNICAL FIELD

The present invention concerns the field of transparent multicontact touch-sensitive sensors. This type of sensor is provided with means for simultaneous acquisition of the position, pressure, size, shape and movement of a plurality of fingers on its surface in order to control equipment, preferably via a graphical interface. They may be used, although this is not limiting on the invention, as interfaces for personal computers, portable or otherwise, cellular telephones, automatic teller machines (banks, points of sale, ticketing), games consoles, portable multimedia players (digital walkman), control of audiovisual equipment or domestic appliances, control of industrial equipment or GPS navigation systems.

The present invention more particularly concerns a multicontact touch-sensitive sensor including an elastically deformable interaction layer and a support layer, the interaction layer having on its lower surface an array of conductive tracks, the support layer having on its upper surface an array of conductive tracks not parallel to the array of conductive tracks of the interaction layer, and said interaction and support layers being separated by a first series of rigid insulating spacers.

### PRIOR ART

There are known in the prior art solutions based on multicontact touch-sensitive sensors making it possible to detect simultaneously the presence and the state of a plurality of contact points. It includes an elastically deformable interaction layer and a support layer, the interaction layer having on its lower surface an array of conductive tracks, the support layer having on its upper surface an array of conductive tracks not parallel to the array of conductive tracks of the interaction layer. The interaction and support layers are separated by spacing means, in particular a first series of rigid insulating spacers.

Thus the conductive tracks are arranged as a matrix of nodes formed by the intersection of rows and columns. In the event of a contact on the touch-sensitive sensor, at least one row and one column come into contact at a node and function as a closed switch. The voltages at the terminals of all the nodes of the matrix are measured sequentially and quickly in order to create an image of the sensor several times per second.

A solution of the above kind is proposed in the French patent document FR 2 866 726. That document describes a multicontact touch-sensitive sensor including two transparent conductive layers on which are printed rows or columns corresponding to conductive wires and an insulative material between said two transparent conductive layers. The insulative material may advantageously consist of rigid insulating spacers of spherical shape disposed between the two conductive layers of the sensor. The conductive tracks are advantageously produced from a surface deposit of indium tin oxide (ITO, or “indium tin oxide” in the English language).

On the one hand this solution has the drawback that interference with the data measured by the sensor impacts significantly on the accuracy and sensitivity of the touch-sensor used. The interference is caused by false detections and phenomena linked to the resistivity of the materials covering the conductive tracks, in particular in the case of a deposit of a transparent conductive material in the form of indium tin oxide. On the other hand, in the event of excessive deformation of a conductive track of the interaction layer, the latter is likely to be damaged or even broken. Thus a sensor of this kind is fragile, which gives it a short service life.

Thus the prior art solutions do not make it possible to benefit from a sensor with conductive tracks that would not prove fragile in the event of a local contact and would not be responsible for phenomena of false detection.

### OBJECT OF THE INVENTION

The object of the present invention is to remedy these technical problems by on the one hand limiting the phenomena of false detection when two conductive tracks of the interaction and support layers, respectively, are moved closer and on the other hand reducing the amplitude of the deformations of the conductive tracks of the interaction layer when a touch-sensitive contact is produced.

Working towards this solution entailed finding means for simultaneously making electrical contact between two conductive tracks of different layers without generating local false detections around the contact point and without excessive deformation of the conductive tracks. The use of a second series of spacers of size and resistance different from those of the first series and disposed in a particular manner relative to the conductive tracks of the two layers has then made it possible, in combination with the first series of rigid insulating spacers, to solve these different technical problems.

To this end, the present invention provides a multicontact touch-sensitive sensor of the type referred to above including an elastically deformable interaction layer and a support layer, the lower surface of the interaction layer having an array of conductive tracks and the upper surface of the supporting layer having an array of conductive tracks that are not parallel to the array of conductive tracks on the interaction layer, said interaction and support layers being separated by a first series of rigid insulating spacers. This sensor also includes a second series of conducting spacers in contact with at least one of the two arrays of conductive tracks. The impedance of the spacers of the second series is between the impedance of the spacers of the first series and the impedance of the conductive tracks. The dimensions of the spacers of the second series are smaller than the dimensions of said spacers of the first series. The dimensions of the spacers of the first series are determined so as to prevent contact in the inactive state and to enable local contact on deformation of the interaction layer between the spacers of the second series and the array of conductive tracks of the layer opposite the spacers of the second series.

Such a sensor, furthermore formed by combining the first and second series of spacers, solves the above technical problems. In fact, since the conductive spacers of the second series are disposed between the conductive tracks of different layers and since their impedance is higher than the impedance of these conductive tracks, the problems of false detection when the conductive tracks of different layers move closer are limited. Moreover, because of the dimensions and positions of the conductive spacers of the second series, they make the electrical contact between the conductive tracks of the different layers when a touch-sensitive contact is required. On such contact, the deformation of the conductive tracks of the interaction layer is limited because they no longer have to come into direct physical contact with the conductive tracks of the support layer.

In a preferred embodiment seeking to obtain the benefit of conductive tracks that are transparent and in a very thin layer, the two arrays of conductive tracks have a conductive surface coating of indium tin oxide.

The interaction layer preferably consists of a polyester film.

The support layer is preferably rigid. In this case, the support layer advantageously consists of a glass substrate.

In preferred embodiments aiming to confer on the sensor sufficient transparency to be integrated into a multipoint touch-sensitive screen necessitating the viewing of graphical objects through the sensor:
the interaction layer is transparent,
the spacers of the first series are formed of a transparent polymer,
the spacers of the second series are formed by a transparent conductive polymer.

In embodiments seeking to improve the distribution of the nodes covered by the sensor, a node being defined by the intersection of a conductive track of one of the two layers with the projection of a conductive track of the other layer:
the two arrays of conductive tracks are mutually perpendicular,
the conductive tracks of at least one of the two arrays of conductive tracks are parallel and equidistant.

In a preferred embodiment, the diameter of the spacers of the first series is more than twice the diameter of the spacers of the second series. The ratio of the dimensions of the spacers of the two series then results in absence of contact in the inactive state and in contact between the spacers of the second series and at least one conductive track of each layer in the event of activation by touch.

The present invention also concerns a controller for such a multicontact touch-sensitive sensor, also comprising a circuit for scanning the conductive tracks and means for acquiring an electrical characteristic on each scanning step, together with a circuit for providing a signal (X, Y, Z_{X,Y}), Z_{X,Y} designating the electrical characteristic measured in a scanning step corresponding to an intersection of a conductive track X of one array and a conductive track Y of the other array.

The present invention further concerns a multicontact touch-sensitive screen comprising a display screen and a multicontact touch-sensitive sensor of the above kind.

The present invention finally concerns a keyboard comprising a set of discrete keys consisting of a multicontact touch-sensitive sensor of the above kind.

### BRIEF DESCRIPTION OF THE DRAWINGS

The invention will be better understood after reading the detailed description of one nonlimiting embodiment of the invention accompanied by figures respectively showing:

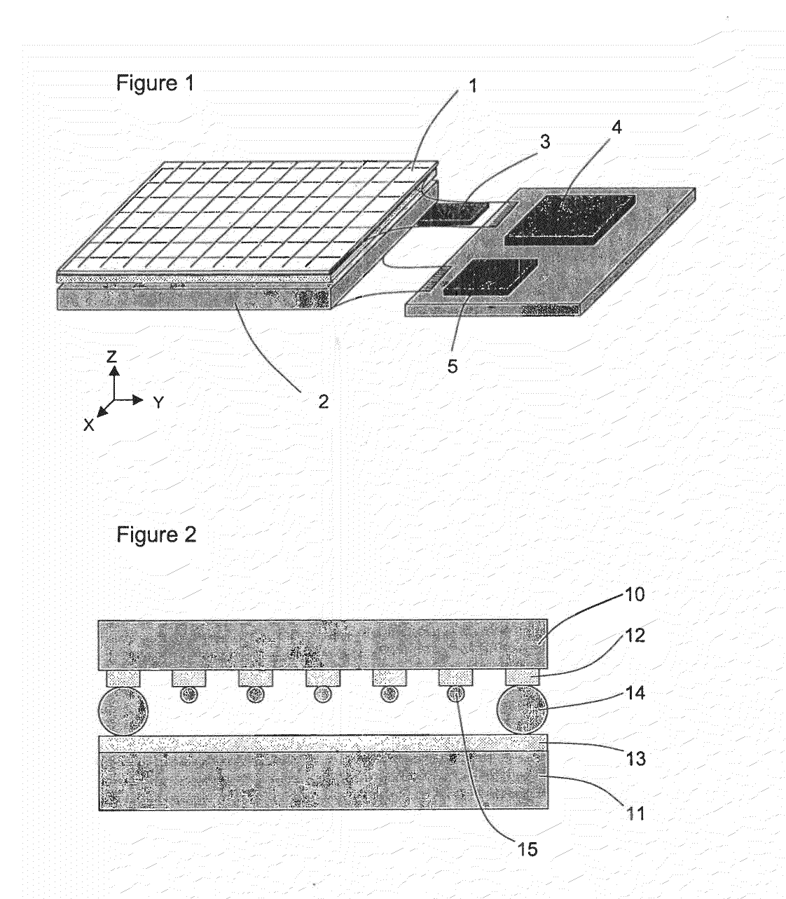

in FIG. 1, a view of a passive matrix multicontact touch-sensitive electronic device into which the multicontact touch-sensitive sensor is integrated,

in FIG. 2, a view in section of a multicontact touch-sensitive sensor of a first embodiment of the present invention,

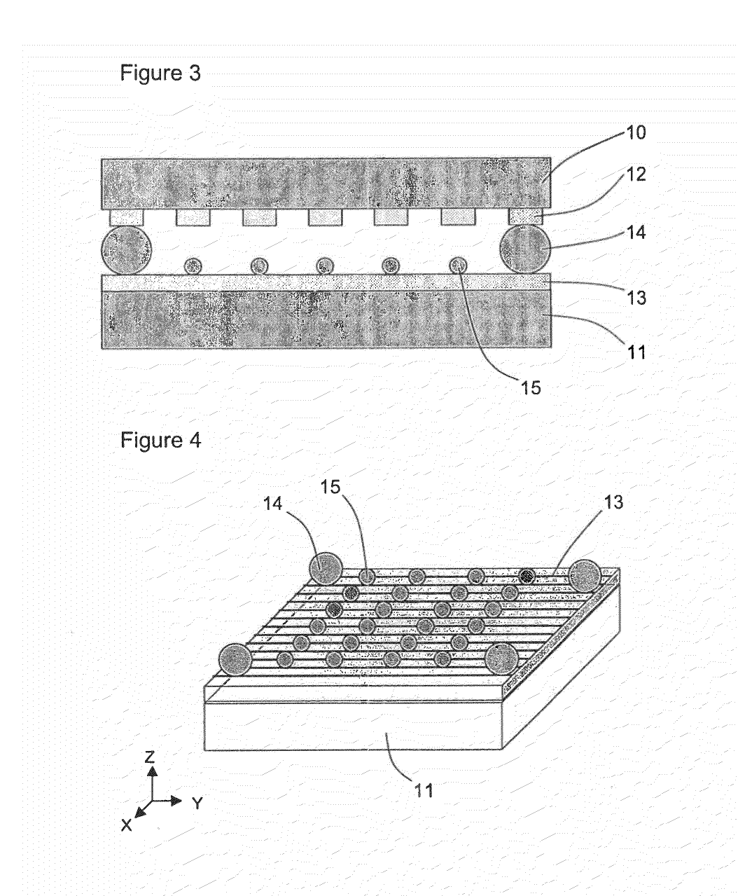

in FIG. 3, a view in section of a multicontact touch-sensitive sensor of a second embodiment of the present invention, and

in FIG. 4, a view in three dimensions of the multicontact touch-sensitive sensor of this second embodiment of the present invention.

### DETAILED DESCRIPTION OF PARTICULAR EMBODIMENTS

A multicontact touch-sensitive sensor of the present invention is of matrix type. It is more particularly a passive matrix, i.e. made up of two transparent conductive material layers arranged as a matrix and separated by an insulating layer.

FIG. 1 represents a view of a passive matrix touch-sensitive electronic device into which the multicontact touch-sensitive sensor is integrated.

This device comprises a matrix touch-sensitive multicontact sensor 1, a display screen 2, a capture interface 3, a main processor 4, and a graphics processor 5.

The first fundamental component of this touch-sensitive device is the touch-sensitive sensor 1, necessary for acquisition—multicontact manipulation—via a capture interface 3. This capture interface 3 contains the acquisition and analysis circuit. The touch-sensitive sensor 1 is of the matrix type. It may be divided into a plurality of parts in order to accelerate capture, these parts being scanned simultaneously.

Data from the capture interface 3 is filtered and sent to the main processor 4. This executes the local program for associating the data from the pad with graphical objects that are displayed on the screen 2 in order to be manipulated. The main processor 4 also sends to the graphical interface 5 data to be displayed on the display screen 2. This graphical interface may furthermore be driven by a graphics processor.

The touch-sensitive sensor is operated in the following manner: during a first scanning phase, the conductive tracks of one of the arrays are energized successively and the response on each of the conductive tracks of the other array is detected. There are determined as a function of these responses contact areas that correspond to the nodes the state whereof has been modified relative to the inactive state. There are determined one or more sets of adjacent nodes the state of which has been modified. A set of such adjacent nodes defines a contact area. There is calculated from this set of nodes position information referred to in the present patent as a cursor. In the case of a plurality of sets of nodes separated by inactive areas, a plurality of independent cursors is determined during a first scanning phase.

This information is refreshed periodically during new scanning phases. The cursors are created, tracked and destroyed as a function of the information obtained during successive scans. For example, the cursor is calculated by a barycentric function of the contact area. The general principle is to create as many cursors as contact areas have been detected on the touch-sensitive sensor and to follow their evolution over time. When the user removes fingers from the sensor the associated cursors are destroyed. In this way it is possible to capture simultaneously the positions of and changes in respect of a plurality of fingers on the touch-sensitive sensor.

The matrix sensor 1 is for example a sensor of the resistive or projected capacitive type. It consists of two transparent layers on which are arranged rows or columns corresponding to conductivetracks. These tracks consist of conductive wires. Thus these two layers of conductive tracks form a matrix array of conductive wires.

To determine if a row has been brought into contact with a column, defining a contact point of the sensor 1, the electrical characteristics—voltage, capacitance or inductance—are measured at the terminals of each node of the matrix. Using a sampling frequency of the order of 100 Hz, the device acquires data from the whole of the sensor 1 by means of the sensor 1 and the control circuit integrated into the main processor 4.

The main processor 4 executes the program for associating the data from the sensor with graphical objects that are displayed on the display screen 2 in order to be manipulated.

FIG. 2 is a view in section of a multicontact touch-sensitive sensor of a first embodiment of the present invention.

This sensor includes an interaction layer 10, a support layer 11, a first series of spacers 14 and a second series of spacers 15.

The interaction layer 10 is elastically deformable. It is produced from a polyester film that resists scratching liable to be caused by a stylus, for example. It has a transparency allowing sufficient clarity for viewing graphical objects on the display screen 2 via the sensor 1.

This interaction layer 10 has an array of parallel and equidistant conductive tracks 12. These tracks are conductive wires produced by a surface deposit of indium tin oxide (ITO).

The support layer 11 is the support element of the sensor 1 on which the elements 10, 12 to 15 are placed. It is produced as a glass substrate and has a transparency providing sufficient clarity for viewing graphical objects on the display screen 2 through the sensor 1.

This support layer 11 features an array of parallel and equidistant conductive tracks 13. These tracks are conductive wires produced by surface deposition of indium tin oxide (ITO). They are disposed perpendicularly to the conductive tracks 12 of the interaction layer 10 so as to form a matrix array of conductive tracks 12, 13.

The conductive tracks 12, 13 are arranged in the form of rows and columns. The intersection of a row and a column forms a contact point. When a finger is placed on the sensor, for example, one or more columns on the interaction layer 10 are brought into contact with one or more rows on the support layer 11 via the conductive spacer 15, creating one or more contact points. This contact is caused by the deformation of the interaction layer 10—and thus of the conductive tracks 12—to the point that an electrical contact is made with the conductive tracks 13 of the support layer 11 via the conductive spacer 15.

In another embodiment, the support layer 11 is deformable but is stiffer than the interaction layer 10 so as not to cause excessive impacts on the support layer 11 at the time of a contact, while allowing sensitivity of touch contact to be obtained via the interaction layer 10.

The first series of spacers 14 separates the interaction layer 10 and the support layer 11—and thus their conductive tracks 12 and 13—with a given spacing over the whole of the sensor 1. To this end, the spacers 14 are disposed between the interaction layer 10 and the support layer 11. The spacers are rigid so as to have a fixed spacing and transparent so as to produce a transparent sensor. They have a very high impedance so as to be insulative. They are produced in a transparent insulative polymer, for example silicone.

The second series of spacers 15 makes it possible on the one hand to prevent the conductive tracks 12 and from moving physically closer—a source of false detection—and to limit the amplitude of deformation of the conductive tracks 12 of the interaction layer 10. To this end, the spacers 15 are transparent to produce a transparent sensor. They may be deposited by screenprinting a transparent conductive polymer and have a spherical shape.

These spacers 15 of the second series have an impedance between the impedance of the spacers of the first series and the impedance of the conductive tracks. This makes it possible to obtain spacers that conduct current. Accordingly, on deformation of the conductive tracks 12 of the interaction layer 10 to make contact by touch, the electrical contact between the tracks 12 and 13 is made via the conductive spacers 15. A resistance, for example, of 100 kilohms is suitable for the needs of current conduction.

The dimensions of the spacers 15 of the second series are less than the dimensions of the spacers 14 of the first series. Moreover, the dimensions of the spacers 14 of the first series are determined so that they:
prevent contact in the inactive state between the spacers 15 of the second series and the array of conductive tracks of the layer opposite the spacers 15 of the second series, and
make local contact on deformation of the interaction layer 10 between the spacers 15 of the second series and the array of conductive tracks of the layer opposite the spacers 15 of the second series.

The diameter of the spacers 14 of the first series is preferably more than twice the diameter of the spacers 15 of the second series. This dimensions ratio makes it possible to prevent contact in the inactive state between the spacers 15 and the conductive tracks 13 and to permit electrical contact between the tracks 12 and 13 via the spacers 15 without, however, the deformation of the tracks 12 of the interaction layer 10 significantly weakening them. The spacers 14 and 15 of the first and second series have respective diameters of 40 micrometers and 20 micrometers, for example.

In another embodiment, the spacers 15 of the second series are the shape of droplets disposed at the intersections of the conductive tracks 12 of the interaction layer 10 with the projections of the conductive tracks 13 of the support layer 11. The spacers may be produced by screenprinting a material which when it dries assumes the shape of a droplet.

In a second embodiment of the sensor shown in FIGS. 3 and 4, the spacers 15 of the first series are at the level of the conductive tracks 13 of the support layer 11. The results obtained with this embodiment are analogous to those obtained with a sensor of the first embodiment described above and shown in FIG. 2.

The embodiments of the present invention described above are provided by way of example and are in no way limiting on the invention. It is to be understood that the person skilled in the art is in a position to produce different variants of the invention without departing from the scope of the patent.

1-14. (canceled)

15. A multicontact touch-sensitive sensor comprising:
an elastically deformable interaction layer and a support layer, a lower surface of the interaction layer including an array of conductive tracks and an upper surface of the supporting layer including an array of conductive tracks that are not parallel to the array of conductive tracks on the interaction layer, the interaction layer and the support layer being separated by a first series of rigid insulating spacers;
a second series of conducting spacers in contact with at least one of the arrays of conductive tracks, impedance of the spacers of the second series being between impedance of the spacers of the first series and impedance of the conductive tracks, dimensions of the spacers of the second series being smaller than dimensions of the spacers of the first series, dimensions of the spacers of the first series being determined so as to prevent contact in an inactive state and to enable local contact on deformation of the interaction layer between the spacers of the second series and the array of conductive tracks of the layer opposite the spacers of the second series.

16. A multicontact touch-sensitive sensor according to claim 15, wherein the two arrays of conductive tracks include a conductive surface coating of indium tin oxide.

17. A multicontact touch-sensitive sensor according to claim 15, wherein the interaction layer includes a polyester film.

18. A multicontact touch-sensitive sensor according to claim 15, wherein the support layer is rigid.

19. A multicontact touch-sensitive sensor according to claim 18, wherein the support layer includes a glass substrate.

20. A multicontact touch-sensitive sensor according to claim 15, wherein the interaction layer is transparent.

21. A multicontact touch-sensitive sensor according to claim 15, wherein the spacers of the first series are formed of transparent polymer.

22. A multicontact touch-sensitive sensor according to claim 15, wherein the spacers of the second series are formed of transparent polymer.

23. A multicontact touch-sensitive sensor according to claim 15, wherein the arrays of conductive tracks are mutually perpendicular.

24. A multicontact touch-sensitive sensor according to claim 15, wherein the conductive tracks of at least one of the arrays of conductive tracks are parallel and equidistant.

25. A multicontact touch-sensitive sensor according to claim 15, wherein the diameter of the spacers of the first series is more than twice the diameter of the spacers of the second series.

26. A controller for a multicontact touch-sensitive sensor according to claim 15, comprising:
a circuit for scanning the conductive tracks; and
means for acquiring an electrical characteristic on each of scanning steps, together with a circuit for providing a signal designating electrical characteristic measured in a scanning step corresponding to an intersection of a conductive track of one array and a conductive track of the other array.

27. A multicontact touch-sensitive screen comprising a display screen and a multicontact touch-sensitive sensor according to claim 15.

28. A keyboard comprising a set of discrete keys including a multicontact touch-sensitive sensor according to claim 15.
